(19) United States
(12) Patent Application Publication
(10) Pub. No.: US 2026/0158655 A1
(43) Pub. Date: Jun. 11, 2026

(54) SIMULATION DEVICE

(71) Applicant: FANUC CORPORATION, Yamanashi (JP)

(72) Inventor: Norio TAKEI, Minamitsuru-gun, Yamanashi (JP)

(73) Assignee: FANUC CORPORATION, Yamanashi (JP)

(21) Appl. No.: 18/707,942

(22) PCT Filed: Jan. 18, 2022
(86) PCT No.: PCT/JP2022/001640

§ 371 Date: May 7, 2024

(51) Int. Cl. B25J 9/16

(52) U.S. Cl. CPC B25J 9/1674; B25J 9/1605

(57) ABSTRACT

Provided is a simulation device with which the cause of an emergency shutdown and the priority of countermeasures can be intuitively recognized. The simulation device comprises: an effect degree calculation unit that calculates, upon occurrence of an emergency shutdown of a robot, a degree of effect on a shaft of the robot; and a display control unit that displays an object corresponding to the degree of effect in a three-dimensional space.

### TECHNICAL FIELD

The present invention relates to a simulation apparatus.

### BACKGROUND ART

A robot has an emergency stop function for safety, and components in an axis of the robot can be damaged by an impact or the like when the robot stops in an emergency, which can cause a failure in the robot. To reduce any effect on the robot due to an emergency stop, a technique has been proposed in which a load and a speed of an axis at the time of the emergency stop are recorded together with a cause of the emergency stop, and a graph is displayed (for example, see Patent Document 1).

### CITATION LIST

### Patent Document

Patent Document 1: Japanese Unexamined Patent Application, Publication No. 2017-100200

### DISCLOSURE OF THE INVENTION

### Problems to be Solved by the Invention

The cause of the emergency stop may include a problem in a design of a robot system, a problem in an operation program, and the like, and in conventional technology, it is difficult to identify where a problem exists. Therefore, there is a demand for a robot simulation apparatus that can intuitively grasp the cause of the emergency stop and a priority of a measure for resolution.

### Means for Solving the Problems

A simulation apparatus according to an aspect of the present disclosure includes: a degree-of-effect calculation unit that is configured to calculate a degree of effect on an axis of a robot when an emergency stop of the robot occurs; and a display control unit that is configured to display, in a three-dimensional space, an object in accordance with the degree of effect.

### Effects of the Invention

According to the present disclosure, it is possible to intuitively grasp a cause of the emergency stop and a priority of a measure for resolution.

### BRIEF DESCRIPTION OF THE DRAWINGS

FIG. 1 is a block diagram illustrating a configuration of a simulation apparatus according to a present embodiment;

FIG. 2 is a diagram illustrating an example that displays, in a three-dimensional space, an object according to the present embodiment;

FIG. 3 is a diagram illustrating an example of dividing the three-dimensional space according to the present embodiment into lattice-shaped regions and of displaying the object in a lattice-shaped region of the lattice-shaped regions; and

FIG. 4 is a flowchart illustrating a process of the simulation apparatus according to the present embodiment.

### PREFERRED MODE FOR CARRYING OUT THE INVENTION

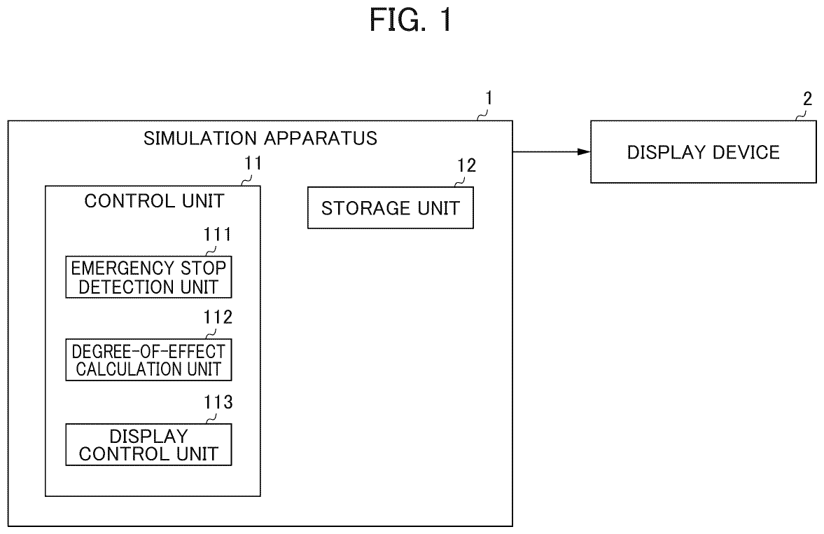

The following describes an example embodiment of the present disclosure. FIG. 1 is a diagram illustrating an outline of a simulation apparatus 1 according to a present embodiment. The simulation apparatus 1 may be, for example, a teach pendant, a robot control apparatus that controls a robot, or a computer apparatus that is connected to the robot or the robot control apparatus. The simulation apparatus 1 may be a simulation apparatus such as a robot guide apparatus, or may be a computer apparatus for a simulation that is not connected to a robot.

The display device 2 displays, based on a signal transmitted from the simulation apparatus 1, various types of information. The display device 2 is configured with, for example, a liquid crystal display (LCD), a cathode ray tube (CRT), or the like.

The simulation apparatus 1 includes a control unit 11 and a storage unit 12. The control unit 11 is configured with a processor such as a central processing unit (CPU) and executes, in the simulation apparatus 1, various types of controls. The control unit 11 includes an emergency stop detection unit 111, a degree-of-effect calculation unit 112, and a display control unit 113.

The storage unit 12 is configured with a storage device such as read-only memory (ROM), a random-access memory (RAM), a hard-disk drive (HDD) and a solid-state drive (SSD), and stores various types of information

The emergency stop detection unit 111 detects an emergency stop of the robot, and notifies the degree-of-effect calculation unit 112 of the emergency stop of the robot. Here, the emergency stop of the robot may be an emergency stop of an actual robot, an emergency stop of software, or an emergency stop of a robot in a simulation.

Here, in the present specification, the emergency stop of the robot includes a stop due to an emergency stop button of an operation panel of a teaching operation panel, a stop due to an emergency stop button of an operation panel of a control apparatus, a stop due to an external emergency stop signal, a stop due to turning off power to a servo and the robot instantaneous stopping or rapid decelerating, a stop due to operation of a dead-man switch of the teaching operation panel, a stop due to a collision detection, a stop due to software, and a stop due to an abnormality of an amplifier, a motor, and the like. That is, the emergency stop of the robot refers to an unexpected stop relating to an operation of the robot.

When the emergency stop of the robot occurs, the degree-of-effect calculation unit 112 calculates a degree-of-effect on an axis of the robot. The display control unit 113 displays, in a three-dimensional space, the object in accordance with the degree of effect calculated by the degree-of-effect calculation unit 112. The display control unit 113 transmits, to the display device 2, a signal for displaying the three-dimensional space, an object, or the like, and the display device 2 displays, based on the signal transmitted from the simulation apparatus 1, the three-dimensional space, the object, or the like.

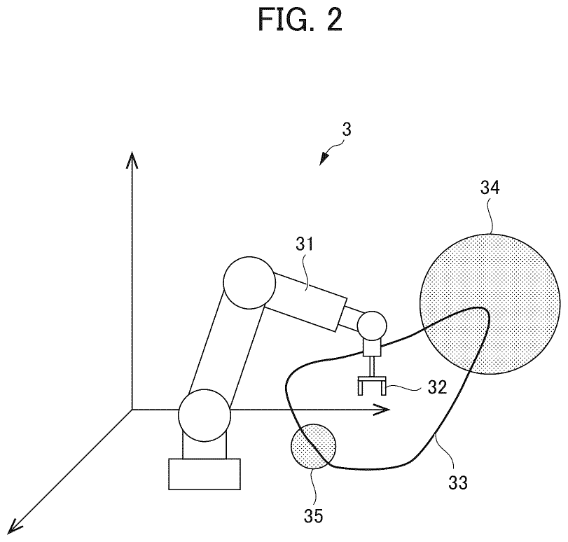

FIG. 2 is a diagram illustrating an example that displays, in a three-dimensional space 3, objects 34 and 35 according to the present embodiment. As illustrated in FIG. 2, the degree-of-effect calculation unit 112 calculates, as the degree of effect, a radius r of a sphere, and the display control unit 113 displays, in the three-dimensional space 3, the sphere that has the radius r as the objects 34 and 35.

In the example illustrated in FIG. 2, when the emergency stop of the robot occurs, the degree-of-effect calculation unit 112 calculates, based on a number of stops that have occurred due to the emergency stop of the robot, the degree of effect on the axis of the robot.

More specifically, the degree-of-effect calculation unit 112 calculates the number of stops and, based on at least one of a load on an axis or a speed of the axis of the robot, the degree of effect. For example, the degree-of-effect calculation unit 112 calculates the radius r of the sphere by using the load on the axis of the robot and a magnitude of the speed at the time of an emergency stop to apply a weighting to the number of times each axis of the robot stops, as illustrated in the following equation.

$$r = e {\sum }_{i = 1}^{n} {WT}_{i} {WS}_{i} E \qquad Equation 1$$

Here, r denotes the radius of the sphere, e denotes a correction coefficient, i denotes the load and a range of the speed of the axis of the robot, WT denotes a load weighting, WS denotes a speed weighting, and E denotes the number of emergency stops (the number of stops). The correction coefficient e is a coefficient for displaying a sphere and is used for determining a relative size with respect to a three-dimensional model 31 of the robot. The load weighting WT and the speed weighting WS each vary in accordance with the load on the axis of the robot and the range i of the speed.

Further, the display control unit 113 displays, in the three-dimensional space 3 and superimposed on the objects 34 and 35, the three-dimensional model 31 of the robot and a motion path 33 for each operation program of the robot. Here, the three-dimensional model 31 of the robot is, for example, a model of a multi-jointed robot, and has a center point (TCP: Tool Center Point) 32 (hereinafter referred to as TCP 32) at a tip of an arm of the robot. The motion path 33 indicates a path of the TCP 32 that operates in accordance with the operation program of the robot. Accordingly, a user may more easily grasp positions of the objects 34 and 35 that are displayed in the three-dimensional space 3.

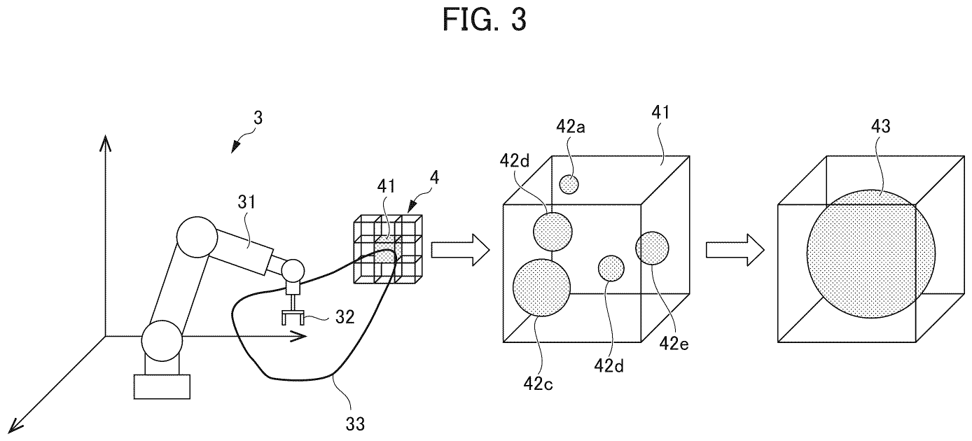

FIG. 3 is a diagram illustrating an example of dividing the three-dimensional space 3 according to the present embodiment into lattice-shaped regions and of displaying the object in a lattice-shaped region of the lattice-shaped regions. In the example illustrated in FIG. 3, the degree-of-effect calculation unit 112 divides the three-dimensional space 3 into a lattice region 4 that includes a plurality of lattice-shaped regions (e.g., regions 41).

In the case of displaying the object in the same manner as in the example shown in FIG. 2, when the emergency stop of the robot occurs, the degree-of-effect calculation unit 112 calculates, based on the number of stops that have occurred due to the emergency stop of the robot, the degree of effect on the axis of the robot. In this case, the display control unit 113 displays, in accordance with the number of stops, a plurality of objects 42a, 42b, 42c and 42d and 42e in the same region 41. However, when such a large number of objects are displayed, the user may find it difficult to grasp the degree of effect from the objects 42a to 42e displayed in the three-dimensional space 3.

Therefore, in the example illustrated in FIG. 3, in a case in which the emergency stop of the robot occurs and a position of the TCP 32 of the robot is in the same region as a position of the TCP 32 of the robot in a previous emergency stop, the degree-of-effect calculation unit 112 adds up the number of stops that occur in the same region. For example, in a case in which the emergency stop of the robot occurs and a position of the TCP 32 of the robot is in the same region 41 as a position of the TCP 32 of the robot in a previous emergency stop, the degree-of-effect calculation unit 112 adds up (counts) the number of stops that occur in the region 41. For example, in the example of FIG. 3, a count number that is described later in the region 41 is 5.

Accordingly, the display control unit 113 displays, in the region 41, one sphere as an object 43 in accordance with the count number that is obtained by adding up the number of stops. Therefore, a user may more easily grasp a position of the emergency stop from the object 43 that is displayed in the three-dimensional space 3.

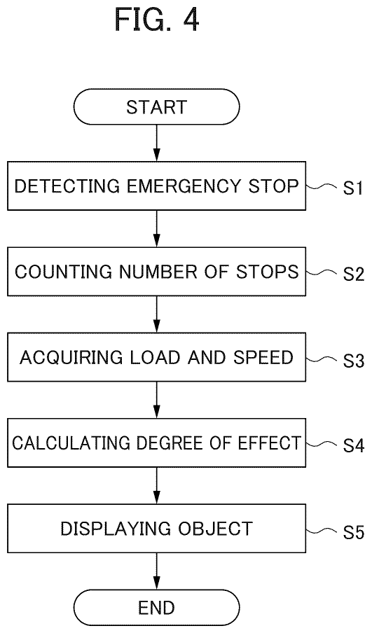

FIG. 4 is a flowchart illustrating a process of the simulation apparatus 1 according to the present embodiment. In Step S1, the emergency stop detection unit 111 detects the emergency stop of the robot and notifies the degree-of-effect calculation unit 112 of the emergency stop of the robot. In Step S2, the degree-of-effect calculation unit 112 counts the number of stops that have occurred due to the emergency stop of the robot.

In Step S3, the degree-of-effect calculation unit 112 acquires the load on the axis and the speed of the axis of the robot upon the emergency stop of the robot occurring.

In Step S4, the degree-of-effect calculation unit 112 calculates, based on a formula for calculating the number of stops, the load on the axis and the speed of the axis of the robot, and the radius r of the sphere, the radius r as the degree of effect.

In Step S5, the display control unit 113 uses the radius r of the sphere as the degree of effect to display, in the three-dimensional space 3, the objects 34 and 35. Further, the display control unit 113 displays, in the three-dimensional space 3 and superimposed on the objects 34 and 35, the three-dimensional model 31 of the robot and a motion path 32 for each operation program of the robot.

In addition, the objects in the above-described embodiment are displayed as spheres, and the shapes of the objects are not limited to spheres. For example, the object may have other three-dimensional shapes such as an ellipsoid, a rectangular parallelepiped, a cube, a cone, a cylinder, a triangular pyramid, a triangular prism, etc.

As described above, according to the present embodiment, the simulation apparatus 1 includes: the degree-of-effect calculation unit 112 that, when the emergency stop of the robot occurs, calculates the degree of effect on the axis of the robot; and the display control unit 113 that displays, in a three-dimensional space, the object in accordance with the degree of effect. With such a configuration, it is possible for the simulation apparatus 1 to quantify the degree of effect on the axis of the robot that has stopped in an emergency and display, in a three-dimensional space, the degree of effect on the axis of the robot that has stopped in an emergency, and thus the user can intuitively grasp a cause of the emergency stop and a priority of a measure for resolution.

The display control unit 113 displays, in the three-dimensional space 3 and superimposed on the objects, the three-dimensional model 31 of the robot and the motion path 33 for each operation program of the robot. Accordingly, the simulation apparatus 1 displays, in the three-dimensional space 3, not only the objects, but also the three-dimensional model 31 and the motion path 33, and thus the user can more easily grasp the positions of the objects displayed in the three-dimensional space 3.

In addition, the degree-of-effect calculation unit 112 calculates the degree of effect based on the number of times that the emergency stop of the robot occurs. Accordingly, the simulation apparatus 1 can display, an object that has a size that corresponds to the number of stops.

The degree-of-effect calculation unit 112 is configured to divide the three-dimensional space 3 into a plurality of lattice-shaped regions and, in a case in which the emergency stop of the robot occurs and a position of an operating part of the robot is in the same region as a position of the operating part of the robot in a previous emergency stop, adds up the number of stops that occur in the same region. Accordingly, the simulation apparatus 1 displays, in the region 41, one sphere as an object 43 in accordance with the count number that is obtained by adding up the number of stops, and the user may more easily grasp a position of the emergency stop from the object 43 that is displayed in the three-dimensional space 3.

The degree-of-effect calculation unit 112 calculates the number of stops that have occurred due to the robot stopping in an emergency and, based on at least one of a load on the axis of the robot and a speed of the axis, the degree of effect. Accordingly, the simulation apparatus 1 can display an object in which the load on the axis and the speed of the axis of the robot has been considered.

The degree-of-effect calculation unit 112 calculates the radius of the sphere as the degree of effect, and the display control unit 113 displays the sphere having the radius as the object on the three-dimensional space 3. Accordingly, the simulation apparatus 1 can quantify the degree of effect by a size of the sphere, and thus the user can intuitively grasp a cause of the emergency stop and a priority of a measure for resolution.

Although the present embodiment of the present disclosure has been described above, the simulation apparatus 1 can be implemented by hardware, software, or a combination thereof. A control method performed by the simulation apparatus 1 can also be implemented by hardware, software, or a combination thereof. Here, “implemented by software” means that the software is implemented by a computer reading and executing a program.

The program may be stored and provided to a computer using various types of non-transitory computer-readable media. Non-transitory computer-readable media includes various types of tangible storage media. Examples of non-transitory computer-readable media include magnetic recording media (for example, hard disk drives), magneto-optical recording media (for example, magneto-optical disks), Read Only Memories (Cited Document-ROMs), CD-Rs, CD-R/Ws, semiconductor memories (For example, a mask ROM, a Programmable ROM (PROM), an Erasable PROM (EPROM), a flash ROM, and a random-access memory (RAM) are used.).

Although each embodiment described above is a preferred embodiment of the present invention, the scope of the present disclosure is not limited to each embodiment described above, and various modifications can be made without departing from the gist of the present disclosure.

### EXPLANATION OF REFERENCE NUMERALS

1 SIMULATION APPARATUS
2 DISPLAY DEVICE
3 THREE-DIMENSIONAL SPACE
4 LATTICE REGION
11 CONTROL UNIT
12 STORAGE UNIT
31 THREE-DIMENSIONAL MODEL
32 TCP
33 MOTION PATH
34, 35, 43 OBJECT
42a, 42b, 42c, 42d, 42e OBJECT
111 EMERGENCY STOP DETECTION UNIT
112 DEGREE-OF-EFFECT CALCULATION UNIT
113 DISPLAY CONTROL UNIT

1. A simulation apparatus comprising:
a degree-of-effect calculation unit that is configured to calculate a degree of effect on an axis of a robot when an emergency stop of the robot occurs; and
a display control unit that is configured to displays in a three-dimensional space, an object in accordance with the degree of effect.

2. The simulation apparatus according to claim 1, wherein the display control unit is configured to display, in the three-dimensional space and superimposed on the object, a three-dimensional model of the robot and a motion path for each operation program of the robot.

3. The simulation apparatus according to claim 1, wherein the degree-of-effect calculation unit is configured to calculate the degree of effect based on a number of stops that have occurred due to the emergency stop of the robot.

4. The simulation apparatus according to claim 3, wherein the degree-of-effect calculation unit is configured to divide the three-dimensional space into a plurality of lattice-shaped regions and, in a case in which the emergency stop of the robot occurs and a position of an operating part of the robot is in the same region as a position of the operating part of the robot in a previous emergency stop, adds up the number of stops that occur in the same region.

5. The simulation apparatus according to claim 3, wherein the degree-of-effect calculation unit is configured to calculate the number of stops and, based on at least one of a load on the axis or a speed of the axis, the degree of effect.

6. The simulation apparatus according to claim 1, wherein
the degree-of-effect calculation unit is configured to calculate a radius of a sphere as the degree of effect, and
the display control unit is configured to display, in the three-dimensional space, the sphere that has the radius as the object.
